(19) United States
(12) Patent Application Publication
(10) Pub. No.: US 2005/0131771 A1
(43) Pub. Date: Jun. 16, 2005

(54) System and method for generating data sets associated with an entity

(76) Inventor: Steven Tischer, Atlanta, GA (US)

Correspondence Address: Philmore H. Colburn II;Cantor Colburn LLP, 55 Griffin Road South, Bloomfield, CT, 06002, US

(21) Appl. No.: 10/736,470

(22) Filed: Dec. 15, 2003

(51) Int. Cl. G06F 17/60

(52) U.S. Cl. 705/26

(57) ABSTRACT

A system and method of generating data sets associated with an entity is provided. The method includes determining when the entity selects a first service or product. The method further includes generating a first data set having a first attribute associated with the first service or product. The method further includes determining when the entity selects a second service or product. The method further includes generating a second data set having a second attribute associated with the second service or product. Finally, the method includes generating a third data set based on the first and second attributes when a portion of data associated with the first attribute is substantially similar to a portion of data associated with the second attribute.

### FIELD OF INVENTION

The present invention relates to a system and a method for generating data sets associated with an entity.

### BACKGROUND

Known computer systems have been utilized to store data sets associated with an individual. For example, when an individual purchases a saleable good using a credit card, a record of the purchase can be stored in a computer system. However, known computer systems have not monitored a plurality of data sets relating to selected or purchased products or services to determine common attributes that indicate an individual's personal interests or preferences.

### SUMMARY OF THE INVENTION

The foregoing problems and disadvantages are overcome by a system and a method for generating data sets associated with an entity.

A method of generating data sets associated with an entity is provided. The method includes determining when the entity selects a first service or product. The method further includes generating a first data set having a first attribute associated with the first service or product. The method further includes determining when the entity selects a second service or product. The method further includes generating a second data set having a second attribute associated with the second service or product. Finally, the method includes generating a third data set based on the first and second attributes when a portion of data associated with the first attribute is substantially similar to a portion of data associated with the second attribute.

A system for generating data sets associated with an entity is provided. The system includes a first device configured to determine when the entity selects a first service or product and generating a first data set having a first attribute associated with the first service or product. The system further includes a second device configured to determine when the entity selects a second service or product and generating a second data set having a second attribute associated with the second service or product. Finally, the system includes a third device configured to generate a third data set based on the first and second attributes when a portion of data associated with the first attribute is substantially similar to a portion of data associated with the second attribute.

Other systems, methods, and computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic of a system for generating data sets associated with an entity.

FIG. 2 is a schematic of exemplary data sets generated by the system of FIG. 1.

FIG. 3 is a flowchart of a method of generating data sets associated with an entity.

### DETAILED DESCRIPTION OF THE INVENTION

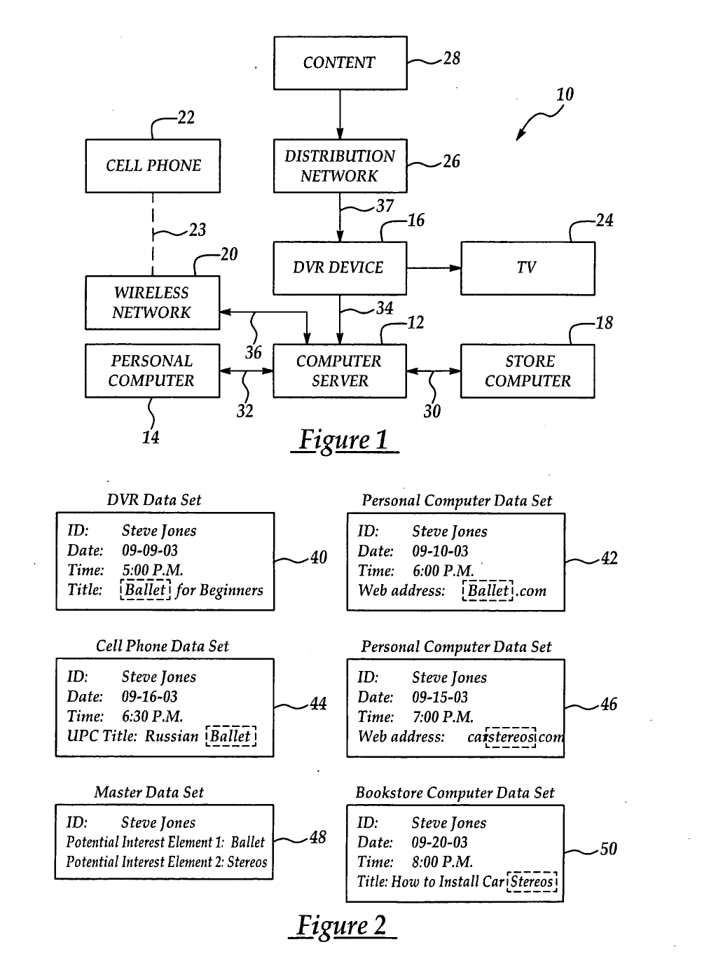

Referring to the drawings, identical reference numerals represent identical components in the various views. Referring to FIG. 1, system 10 is utilized to monitor the selections of an entity and to generate a master data set based upon the selections in order to determine an entity's personal interests or preferences. An “entity” may comprise a person or a predetermined group of people. A “selection” may comprise: (i) electronically selecting a product or a service, (ii) accessing or selecting a particular piece of information, (iii) purchasing a product or service, or (iv) ordering a product or service.

System 10 includes a computer server 12, a personal computer 14, a store computer 18, a digital video recording (DVR) device 16, a wireless network 20, a cell phone 22, a TV 24, a distribution network 26, and content 28.

Computer server 12 is provided to generate a “master data set” associated with an entity that corresponds to the preferences or interests of the entity. In particular, computer server 12 may be configured to query store computer 18, personal computer 14, DVR device 16, and cell phone 22 for data sets generated therein. Server 12 communicates with store computer 18, personal computer 14, and DVR device 16, via communication channels 30, 32, 34, respectively. Server 12 communicates with wireless network 20 via communication channel 36 to further communicate with cell phone 22. Further, computer server 12 may be operatively connected to a grid computer network (not shown) and allocate computational tasks to the grid computer network for generating the “master data set.”

Referring to FIG. 2, before proceeding with a detailed discussion of the remaining components of system 10, a discussion of the data sets received by computer server 12 will be discussed. It should be noted that each of the queried data sets 40, 42, 44, 46, 50 includes the following attributes: (i) ID, (ii) Date, (iii) Time. The ID attribute corresponds to a unique identifier associated with an entity. For example, the ID attribute may represent: (i) the name of an individual or group of people, (ii) the social security number of an individual, (iii) a driver's license number of an individual, or (iv) a zip code. The Date attribute corresponds to the calendar date of a selection or purchase of a service or product by an entity. The Time attribute corresponds to the time of the selection or purchase of a service or product by an entity.

Data set 40 is generated by DVR device 16. As shown, data set 40 may include the following attributes: (i) ID, (ii) Date, (iii) Time, (iv) Title. The Title attribute corresponds to a title of a program or movie that was selected by the entity to be recorded by DVR device 16, such as a program entitled “Ballet for Beginners”, for example.

Data sets 42, 46 correspond to data sets that may be generated by personal computer 14. Data sets 42, 46 include the following attributes: (i) ID, (ii) Date, (iii) Time, and (iv) Web Address. In particular, personal computer 14 may monitor the web addresses accessed by the entity using a conventional Web browser, and create data sets 42, 46 for two Web addresses accessed by the entity. Data set 42 indicates that the web address “ballet.com” was accessed by the entity. Data set 46 indicates the web address “carstereos.com” was accessed by the entity.

Data set 50 corresponds to a data set that may be generated by a store computer 18. Data set 50 may include the following attributes: (i) ID, (ii) Date, (iii) Time, and (iv) Title. The Title attribute may correspond to the name a product purchased by the entity, such as a book entitled “How to Install Car Stereos”.

Data set 44 corresponds to a data set that may be generated by cell phone 22 having a barcode scanner (not shown) incorporated therein. For example, an entity may scan a barcode corresponding to a book entitled “Russian Ballet” which induces cell phone 22 to generate data set 44. Data set 44 may include the following attributes: (i) ID, (ii) Date, (iii) Time, and (iv) UPC Title.

Referring again to FIG. 1, a detailed description of the remaining components of system 10 will now be described. Personal computer 14 is provided to generate data sets 42, 46 corresponding to web addresses (i.e., URL identifiers) accessed by the entity using computer 14. Computer 32 communicates with computer server 12 via communication channel 32.

Store computer 18 is provided to generate data sets associated with an entity based upon selections of services or products by the entity at a particular store. It should be noted that a plurality of store computers 18 could be utilized (e.g. one or more store computers 18 for each store) in system 10. Referring to FIG. 2, an exemplary data set 50 is illustrated that may be generated by store computer 18 when an entity purchases a book which induces computer 18 to generate data set 50 and store data set 50 in internal memory of computer 18. Computer server 12 may periodically query store computer 18 for the data sets stored in the internal memory of computer 18. Alternately, computer 18 can periodically transmit stored data sets to computer server 12.

DVR device 16 is provided to record television shows and/or movies selected by the entity. In particular, content 28 from a service provider (e.g., MSNBC, ESPN, etc) is broadcast through a distribution network 26 to DVR device 16. The entity can selectively program device 16 to record predetermined content from network 26 for later viewing by the entity. DVR device 16 communicates with distribution network 26 via communication channel 37. DVR device 16 may be further coupled to a TV 24. DVR device 16 may generate one or more data sets 40 corresponding to content selected by the entity and thereafter store the data sets in an internal memory of device 16. As shown, data set 40 indicates that the entity selected to record either a movie or TV program entitled “Ballet for Beginners”. Computer server 12 may periodically query DVR device 16 for the data sets stored in the internal memory of device 16. Alternately, device 16 can periodically transmit data sets generated in device 16 to computer server 12.

Cell phone 22 is provided to record information related to products or services selected by the entity. Cell phone 22 may include a barcode reader (not shown) that an entity can use to scan a bar code associated with products or services that the entity may be interested in purchasing immediately or at a later time. When the entity uses the cell phone 20 to scan in barcode information using the barcode reader, cell phone 22 can generate data set 44 and store the data set in an internal memory of cell phone 22. As shown in data set 44, the entity scanned in a barcode relating to a book entitled “Russian Ballet”. As shown, cell phone 22 can transmit RF signals 23 representing data set 44 to wireless network 20. Thereafter, wireless network 20 can transmit data set 44 to computer server 12. Computer server 12 may periodically query cell phone 22 via wireless network 20 for the data sets stored in the internal memory of phone 22. Alternately, cell phone 22 can periodically transmit data sets generated in phone 22 via wireless network 20 to computer server 12.

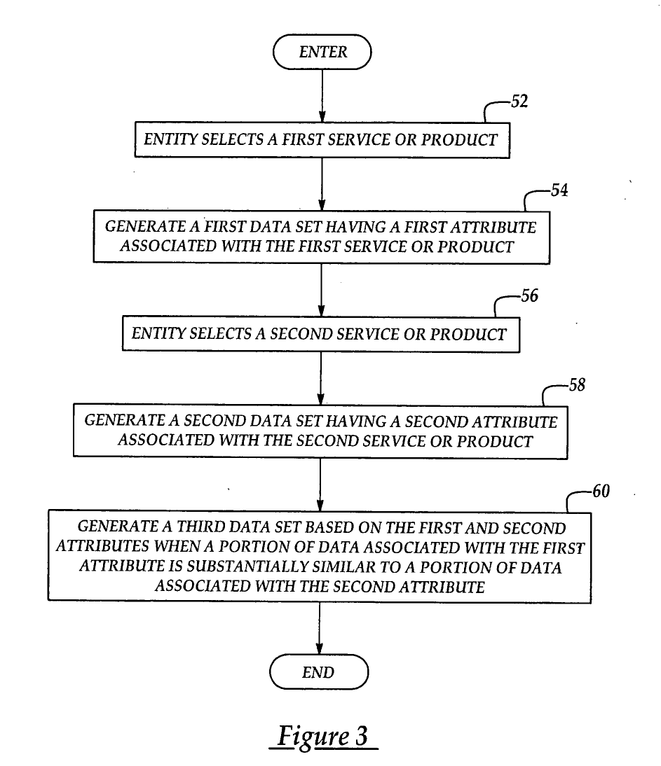

Referring to FIG. 3, method for generating data sets associated with an entity will be described. At step 52, the entity selects a first service or product. The term “product” used herein comprises any type of product they can be physically or electronically exchanged between the entity and a third-party. For example, the term “product” includes: (i) physical objects, and (ii) information that can be transmitted in an electronic format such as movies, TV programs, web pages, data files, streaming data, and software programs. The selection may comprise for example: (i) electronically selecting a product or a service, (ii) accessing or selecting a particular piece of information, (iii) purchasing a product or service, (iv) ordering a product or service.

Next at step 54, a first device generates a first data set having a first attribute associated with the first service or product. For example, one of store computer 18, personal computer 14, DVR device 16, cell phone 22, can generate one of data sets 50, 42, 40, 44, respectively having the attributes discussed above.

Next at step 56, the entity selects a second service or product.

Next at step 58, a second device generates a second data set having a second attribute associated with the second service or product. For example, one of store computer 18, personal computer 14, DVR device 16, cell phone 22, can generate another one of data sets 50, 42, 40, 44, respectively, having the attributes discussed above.

Next at step 60, computer server 12 can generate a third data set based on the first and second attributes when a portion of the data associated with the first attribute is substantially similar to a portion of data associated with the second attribute. In particular, computer server 12 can perform a text comparison of: (i) the Title attribute of data set 40 containing the text string “Ballet for Beginners”, (ii) the web address attribute of data set 42 containing the text string “ballet.com”, and (iii) the Title attribute of data set 44 containing the text string “Russian Ballet” to determine a common text string “ballet”contained in each of the data sets 40, 42, 44. Further, the computer server 34 can perform at text comparison of: (i) the web address attribute of data set 46 containing “carstereos.com” and (ii) the title attribute of data set 50 containing the text string “How to Install Car Stereos” to determine a common text string “stereo” contained in each of the data sets 46, 50.

Thereafter, computer server 12 can generate a master data set 48 that includes the following attributes: (i) ID, (ii) Potential Interest Element1, and (iii) Potential Interest Element2. In particular, server 12 can compare the text strings in each of the data sets to the text strings in the remaining data sets to determine that the queried data sets have three occurrences of the text string “ballet” and two occurrences of the text string “stereo.” Thereafter, server 12 can assign the most commonly occurring text string to the attribute Potential Interest Element1 and the second most commonly occurring text string to attribute Potential Interest Element2. It should be noted that although only two Potential Interest Elements are shown in data set 48, a plurality of additional Potential Interest Element attributes could be included in this master data set indicative of other preferences and/or interests of the entity. Further, the master data set 48 can be periodically updated based upon data sets queried from the various devices by computer server 12. Further, computer server 12 may assign an occurrence number (not shown) to each Potential Interest Element attribute in data set 48. Server 12 can utilize the occurrence number to rank order the Potential Interest Element attributes according to the number of matched text strings associated with a Potential Interest Element attribute that occur over a predetermined time period.

The inventive system and method for generating data sets associated with an entity provides a substantial advantage over known systems and methods. In particular, the system and method generate a plurality of data sets based upon selections of products and services made by an entity and then determining common attributes that indicate the personal interests or preferences of the entity. Thus, the system and method can automatically determine personal interests or preferences without having the entity answer or fill out questionnaires regarding their personal interests or preferences.

As described above, the present invention can be embodied in the form of computer-implemented processes and apparatuses for practicing those processes. In an exemplary embodiment, the invention is embodied in computer program code executed by one or more network elements. The present invention may be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of generating data sets associated with an entity, comprising:
determining when the entity selects a first service or product;
generating a first data set having a first attribute associated with the first service or product;
determining when the entity selects a second service or product;
generating a second data set having a second attribute associated with the second service or product; and,
generating a third data set based on the first and second attributes when a portion of data associated with the first attribute is substantially similar to a portion of data associated with the second attribute.

2. The method of claim 1 wherein the determining when the entity selects the first service or product comprises determining whether the entity purchases the first service or product.

3. The method of claim 1 wherein the determining when the entity selects the first service or product comprises determining whether the entity submits an order for the first service or product.

4. The method of claim 1 wherein the portion of the data associated with the first attribute comprises textual data and the portion of the data associated with the second attribute comprises textual data.

5. The method of claim 4 wherein the generating the third data set based on the first and second attributes includes:
determining whether at least a portion of the textual data of the first attribute is identical to at least a portion of the textual data of the second attribute; and,
forming the third data set having a third attribute containing at least a portion of textual data from one of the first and second attributes.

6. The method of claim 1 wherein a first network device generates the first data set.

7. The method of claim 6 wherein a second network device generates the second data set.

8. The method of claim 7 wherein a third network device generates the third data set.

9. The method of claim 1 wherein the entity comprises one of a person and a group of people.

10. A system for generating data sets associated with an entity, comprising:
a first device configured to determine when the entity selects a first service or product and generating a first data set having a first attribute associated with the first service or product;
a second device configured to determine when the entity selects a second service or product and generating a second data set having a second attribute associated with the second service or product; and,
a third device configured to generate a third data set based on the first and second attributes when a portion of data associated with the first attribute is substantially similar to a portion of data associated with the second attribute.

11. The system of claim 10 wherein the first device is further configured to determine when the entity selects the first service or product by determining whether the entity purchases the first service or product.

12. The system of claim 10 wherein the first device is further configured to determine when the entity selects the first service or product by determining whether the entity submits an order for the first service or product.

13. The system of claim 10 wherein the portion of the data associated with the first attribute comprises textual data and the portion of the data associated with the second attribute comprises textual data.

14. The system of claim 10 wherein the third device is further configured to generate the third data set by determining whether at least a portion of the textual data of the first attribute is identical to at least a portion of the textual data of the second attribute, and forming the third data set having a third attribute containing at least a portion of textual data from one of the first and second attributes.

15. The system of claim 10 wherein the entity comprises one of a person and a group of people.

16. The system of claim 10 wherein the first device comprises a first network device.

17. The system of claim 16 wherein the second device comprises a second network device.

18. The system of claim 10 wherein the first device comprises one of a computer, a cellular phone, and a digital video recording device.

19. The system of claim 10 wherein the third device is operably associated with a grid computer network.

20. The system of claim 10 wherein the third device comprises a computer server communicating with the first and second devices.

21. A storage medium encoded with machine-readable computer program code for generating data sets associated with an entity, the storage medium including instructions for causing at least one network element to implement a method comprising:
determining when the entity selects a first service or product;
generating a first data set having a first attribute associated with the first service or product;
determining when the entity selects a second service or product;
generating a second data set having a second attribute associated with the second service or product; and,
generating a third data set based on the first and second attributes when a portion of data associated with the first attribute is substantially similar to a portion of data associated with the second attribute.

22. A method of generating dynamic data sets associated with a legal entity, comprising:
generating a plurality of historic data sets by monitoring activities of the legal entity;
identifying a plurality of attributes contained in the plurality of historic data sets;
determining a plurality of values wherein each value is associated with one attribute of the plurality of attributes and corresponds to a number of historic data sets of the plurality of historic data sets containing the one attribute; and
generating a plurality of dynamic data sets containing the attributes wherein the plurality of dynamic data sets are ranked based on the plurality of values.

23. The method of claim 22, further comprising iteratively generating the plurality of historic data sets by monitoring activities of the legal entity.

24. A method of generating a dynamic data set associated with a legal entity, comprising:
generating first and second historic data sets from first and second activities, respectively, of the legal entity;
associating at least a first attribute of the first historic data set with at least a second attribute of the second historic data set, the first attribute being substantially similar to the second attribute; and
generating a third dynamic data set based on at least one of the first and second attributes of the first and second historic data sets, respectively.

25. The method of claim 24, wherein the first activity is an activity associated with at least one of a computer, a cell phone, and a digital video recorder.
